(19) United States
(12) Patent Application Publication
(10) Pub. No.: US 2016/0140783 A1
(43) Pub. Date: May 19, 2016

(54) METHOD FOR DIAGNOSING A HORIZONTAL STABILIZER FAULT

(71) Applicant: GE AVIATION SYSTEMS LIMITED, Gloucestershire (GB)

(72) Inventors: Christopher Joseph CATT, Eastleigh, Hampshire (GB); Mark John ROBBINS, Eastleigh, Hampshire (GB)

(21) Appl. No.: 14/901,649

(22) PCT Filed: Jun. 28, 2013
(86) PCT No.: PCT/EP2013/063714

§ 371 Date: Dec. 28, 2015

(51) Int. Cl. G07C 5/08; B64F 5/00

(52) U.S. Cl. CPC G07C 5/0808; G07C 5/0816; B64F 5/0045

(57) ABSTRACT

A method of diagnosing a horizontal stabilizer system fault in an aircraft, where the method includes receiving data relevant to a characteristic of the pitch of the aircraft during flight, comparing the received data to a reference pitch characteristic, diagnosing a fault in the horizontal stabilizer system based on the comparison, and providing an indication of the diagnosed fault.

### CROSS-REFERENCE TO RELATED APPLICATIONS

This application is a national stage application under 35 U.S.C. §371(c) of prior filed, co-pending PCT application serial number PCT/EP2013/063714, filed on Jun. 28, 2013, titled “METHOD FOR DIAGNOSING A HORIZONTAL STABILIZER FAULT”. The above-listed application is herein incorporated by reference.

### BACKGROUND

Contemporary aircraft include horizontal stabilizers to control the up-and-down, or pitching, motion of the aircraft nose. Elevators on the horizontal stabilizers move and vary the amount of force generated by the tail surface. The elevators are used to generate and control the pitching motion of the aircraft. Currently, airlines and maintenance personnel wait until a fault or problem occurs with the system and then attempt to identify the cause and fix it either during scheduled or, more likely, unscheduled maintenance.

### BRIEF DESCRIPTION

Embodiments of the innovation relate to a method of diagnosing a horizontal stabilizer system fault in an aircraft, including receiving data relevant to a characteristic of the pitch of the aircraft during flight, comparing the received data to a reference pitch characteristic, diagnosing a fault in the horizontal stabilizer system based on the comparison, and providing an indication of the diagnosed fault.

### BRIEF DESCRIPTION OF THE DRAWINGS

In the drawings:

FIG. 1 is an example perspective view of the aircraft and a ground station in which embodiments of the innovation may be implemented; and

FIG. 2 is an example flowchart showing a method of diagnosing a horizontal stabilizer fault in an aircraft according to an embodiment of the innovation.

### DETAILED DESCRIPTION

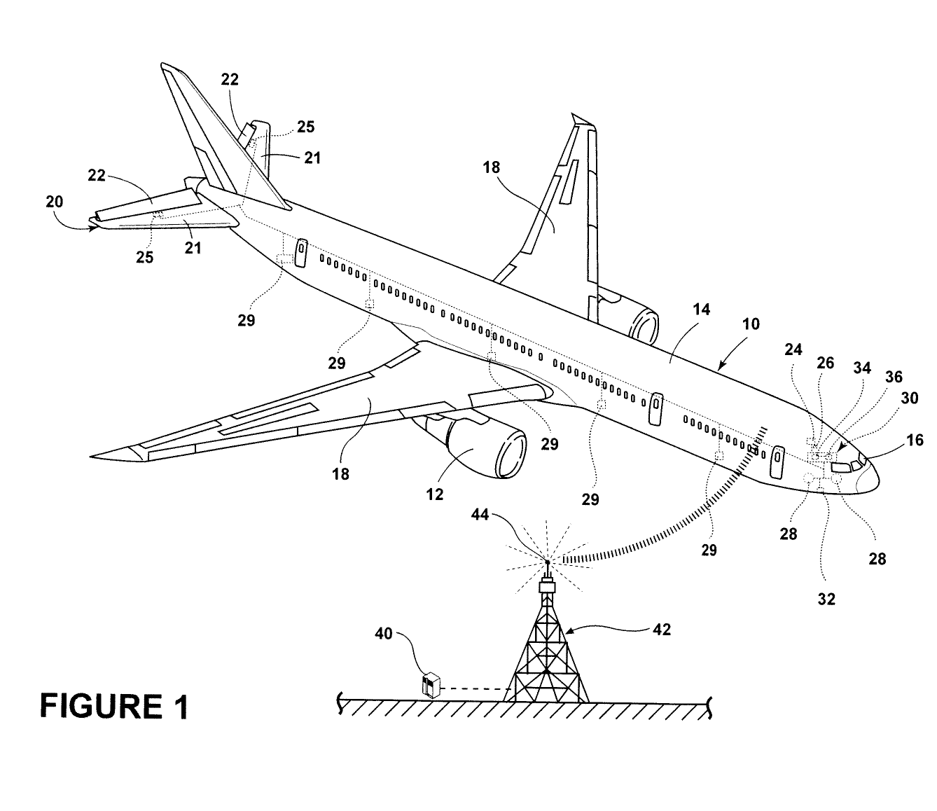

FIG. 1 schematically depicts a portion of an aircraft 10 that may execute embodiments of the innovation and may include one or more propulsion engines 12 coupled to a fuselage 14, a cockpit 16 positioned in the fuselage 14, and wing assemblies 18 extending outward from the fuselage 14. A horizontal stabilizer system 20 is included in the aircraft 10 and includes horizontal stabilizers 21, which are fixed wing sections extending from a rear portion of the fuselage. There is an elevator 22 for each of the horizontal stabilizers 21, which may include moving sections at the rear of the horizontal stabilizers 21. The elevators 22 may be operably coupled to the fixed horizontal stabilizers 21 by hinges or other mechanisms.

A control mechanism 24 such as a trim lever may be included in the cockpit 16 and may be operated by a pilot to set the position of the elevators 22. The control mechanism 24 may provide an input to a drive 25, which may be used to move the elevators 22 into the position set by the control mechanism 24. The term trim lever as used in this description is not limited to a physical lever, rather it relates to the control device used to set the position of the elevators. Throughout the early part of aviation, this control device was a lever and the term flap handle has now become generic to the control device used to set the elevator position, regardless of whether the control device is an actual lever or a button on a touch-screen user interface. Other control mechanisms including a flap handle may also be included but have not been shown for clarities sake. Further, a sensor such as a control mechanism sensor 26 or other suitable mechanism may be used for determining the position of the control mechanism 24. Further, one or more sensors 28 may be included in the horizontal stabilizer system 20 and each may output data relevant to a characteristic of the pitch of the aircraft 10 during flight. For example, one of the sensors 28 may include a tilt sensor to determine a pitch of the aircraft 10.

A plurality of additional aircraft systems 29 that enable proper operation of the aircraft 10 may also be included in the aircraft 10 as well as a controller 30, and a communication system having a wireless communication link 32. The controller 30 may be operably coupled to the plurality of aircraft systems 29 including the horizontal stabilizer system 20. For example, the horizontal stabilizer drive 25, the control mechanism 24, the control mechanism sensor 26, and the one or more sensors 28 may be operably coupled to the controller 30.

The controller 30 may also be connected with other controllers of the aircraft 10. The controller 30 may include memory 34, the memory 34 may include random access memory (RAM), read-only memory (ROM), flash memory, or one or more different types of portable electronic memory, such as discs, DVDs, CD-ROMs, etc., or any suitable combination of these types of memory. The controller 30 may include one or more processors 36, which may be running any suitable programs. The controller 30 may be a portion of an FMS or may be operably coupled to the FMS.

A computer searchable database of information may be stored in the memory 34 and accessible by the processor 36. The processor 36 may run a set of executable instructions to display the database or access the database. Alternatively, the controller 30 may be operably coupled to a database of information. For example, such a database may be stored on an alternative computer or controller. It will be understood that the database may be any suitable database, including a single database having multiple sets of data, multiple discrete databases linked together, or even a simple table of data. It is contemplated that the database may incorporate a number of databases or that the database may actually be a number of separate databases.

The database may store data that may include historical data related to the reference pitch characteristics as well as historical horizontal stabilizer data for the aircraft 10 and related to a fleet of aircraft. The database may also include reference values including trim rates for the aircraft and expected changes in pitch for those trim rates.

Alternatively, it is contemplated that the database may be separate from the controller 30 but may be in communication with the controller 30 such that it may be accessed by the controller 30. For example, it is contemplated that the database may be contained on a portable memory device and in such a case, the aircraft 10 may include a port for receiving the portable memory device and such a port would be in electronic communication with controller 30 such that controller 30 may be able to read the contents of the portable memory device. It is also contemplated that the database may be updated through the wireless communication link 32 and that in this manner, real time information such as information regarding historical fleet wide data may be included in the database and may be accessed by the controller 30.

Further, it is contemplated that such a database may be located off the aircraft 10 at a location such as airline operation center, flight operations department control, or another location. The controller 30 may be operably coupled to a wireless network over which the database information may be provided to the controller 30.

While a commercial aircraft has been illustrated, it is contemplated that portions of the embodiments of the innovation may be implemented anywhere including in a computer 40 at a ground system 42. Furthermore, database(s) as described above may also be located in a destination server or a computer 40, which may be located at and include the designated ground system 42. Alternatively, the database may be located at an alternative ground location. The ground system 42 may communicate with other devices including the controller 30 and databases located remote from the computer 40 via a wireless communication link 44. The ground system 42 may be any type of communicating ground system 42 such as an airline control or flight operations department.

One of the controller 30 and the computer 40 may include all or a portion of a computer program having an executable instruction set for diagnosing a horizontal stabilizer fault in the aircraft 10. Such faults may include improper operation of components as well as failure of components. Regardless of whether the controller 30 or the computer 40 runs the program for diagnosing the fault, the program may include a computer program product that may include machine-readable media for carrying or having machine-executable instructions or data structures stored thereon. Such machine-readable media may be any available media, which can be accessed by a general purpose or special purpose computer or other machine with a processor. Generally, such a computer program may include routines, programs, objects, components, data structures, algorithms, etc. that have the technical effect of performing particular tasks or implementing particular abstract data types. Machine-executable instructions, associated data structures, and programs represent examples of program code for executing the exchange of information as disclosed herein. Machine-executable instructions may include, for example, instructions and data, which cause a general purpose computer, special purpose computer, or special purpose processing machine to perform a certain function or group of functions.

It will be understood that the aircraft 10 and computer 40 merely represent embodiments that may be configured to implement embodiments or portions of embodiments of the innovation. During operation, either the aircraft 10 and/or the computer 40 may diagnose a horizontal stabilizer fault. By way of non-limiting example, while the aircraft 10 is being operated the control mechanism 24 may be utilized to set the position of the elevators 22 by either trimming up or trimming down the position of the elevators 22. The control mechanism sensor 26 may output a signal indicative of the position of the control mechanism 24 and whether it is being directed to trim up or trim down the aircraft. Further, the sensors 28 may output data relevant to a characteristic of the pitch of the aircraft 10 during flight.

The controller 30 and/or the computer 40 may utilize inputs from the control mechanism sensor 26, the sensors 28, the database(s) and/or information from airline control or flight operations department to diagnose the horizontal stabilizer fault. Among other things, the controller 30 and/or the computer 40 may analyze the data output by the control mechanism sensor 26 and the one or more sensors 28. The controller 30 and/or the computer 40 may also analyze the horizontal stabilizer data to determine differences between the expected change in pitch and the actual change in pitch. Once a horizontal stabilizer fault has been diagnosed an indication may be provided on the aircraft 10 and/or at the ground system 42. It is contemplated that the diagnosis of the horizontal stabilizer fault may be done during flight, may be done post flight, or may be done after any number of flights. The wireless communication link 32 and the wireless communication link 44 may both be utilized to transmit data such that the fault may be diagnosed by either the controller 30 and/or the computer 40.

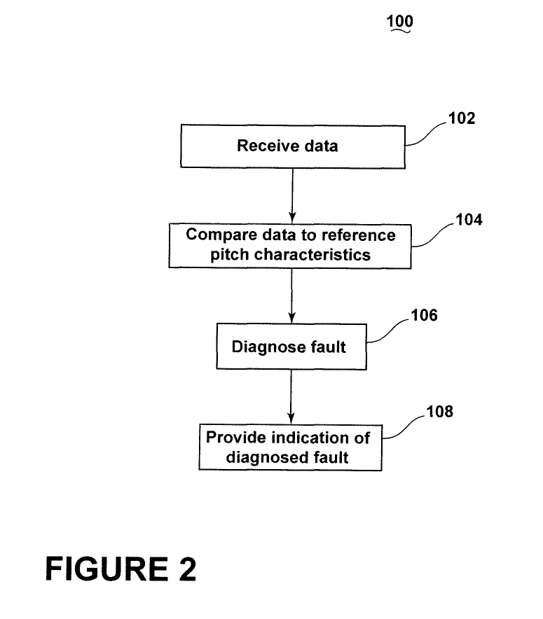

In accordance with an embodiment of the innovation, FIG. 2 illustrates a method 100, which may be used for diagnosing a horizontal stabilizer fault, which may include a failure. The method 100 begins at 102 by receiving data relevant to a characteristic of the pitch of the aircraft 10 during flight. This may include receiving data from one or more of the sensors 28 operably coupled to the horizontal stabilizer system 20.

It is contemplated that the received data may be raw aircraft data from which a variety of other information may be derived or otherwise extracted. For example, the raw data that may be received may consist of date times, altitudes, flap handle positions, pitch trim positions, on ground/in air information, manual trim commands, and autopilot trim commands. From this data information such as a rate of change of pitch may be determined. It will be understood that regardless of whether the data is received directly or derived from received data, the data may still be considered to be received data.

The data received may include rate of change of the pitch of the aircraft, the median pitch of the aircraft, a median pitch trim rate of the aircraft, minimum pitch trim rates of the aircraft, median pitch trim position of the aircraft, a count of pitch trim outliers. The number of times the aircraft is trimmed up or trimmed down may be an indirect indication of how the elevators 22 are performing. In such an instance the received data may include a difference in autopilot trim up and down commands, a difference in manual trim up and down commands, and a difference in actual and expected pitch of the aircraft. The data may be received during a number of different regimes. For example, the data may be received during the whole flight, during the longest ‘cruise’ period, over all cruise periods, takeoff, landing, etc. The data may also be received for a number of flights. For example, the median may be determined from data received from different phases of the aircraft flight.

At 104, the received data may be compared to a reference pitch characteristic. The reference pitch characteristic may include any number of reference pitch characteristics related to the horizontal stabilizer system 20 and the aircraft 10. For example, the reference pitch characteristic may include one or more threshold values including minimum and maximum threshold values. For example, reference threshold values may include the rates shown in Table 1 below.

TABLE 1
Threshold Values

| Feature | Minimum value | Maximum value |
|---|---|---|
| Median pitch trim position | 1.24° | 3° |
| Median pitch trim rate | 0.065 dps | 0.09 dps |
| Number of trim position outliers | Not Applicable | 3 |
| Minimum pitch trim rates | 0.01 dps | Not Applicable |
| Difference in autopilot trim up and | Not Applicable | 40 |
| Difference in manual trim up and | Not Applicable | 10 |
| Difference in actual and expected | Not Applicable | 1.5° |

By way of further examples, the reference pitch characteristic may include a value related to a minimum acceptable rate of change, predetermined rate of change of pitch of the aircraft in response to a trim up command from the pilot/autopilot, a predetermined rate of change of pitch of the aircraft in response to a trim down command from the pilot/autopilot, etc. The reference pitch characteristic may also include a historical reference pitch characteristic including for example historical data related to the horizontal stabilizer system of the aircraft or historical data for multiple other aircraft. Thus, data received may be compared to results obtained from previous flights for the same aircraft and against the whole fleet of aircraft. Furthermore, the reference pitch characteristic may include a value that has been determined during flight such as by receiving an output of one of the sensors 28. In this manner, it will be understood that the reference pitch characteristic may be defined during operation. Alternatively, the reference positions values may be stored in one of the database(s) as described above. In this manner, the data received from the sensors 28 may be compared to a pitch characteristic reference value. For example, the comparison may include determining if the data received is within a range of values or is out of bounds.

At 106, a fault in the horizontal stabilizer system may be diagnosed based on the comparison at 104. For example, a fault in the horizontal stabilizer system 20 may be diagnosed when the comparison indicates the received data is out of bounds or infeasible. In this manner, the controller 30 and/or the computer 40 may determine if the results of the comparison are acceptable. A fault may also be determined when the comparison indicates that the received data satisfies a predetermined threshold. The term “satisfies” the threshold is used herein to mean that the variation comparison satisfies the predetermined threshold, such as being equal to, less than, or greater than the threshold value. It will be understood that such a determination may easily be altered to be satisfied by a positive/negative comparison or a true/false comparison. For example, a less than threshold value can easily be satisfied by applying a greater than test when the data is numerically inverted. It is also contemplated that the received data is relevant to multiple pitch characteristics and that comparisons may be made between the multiple pitch characteristics and corresponding multiple reference pitch characteristics.

Any number of faults in the horizontal stabilizer system 20 may be diagnosed including a flight recorder fault, stability sensor fault, pitch range and rate calibration faults, automatic trim is inoperable, etc. For example, a flight recorder or stability sensor fault may be diagnosed by comparing median pitch trim positions, median pitch trim rates, number of pitch trim position outliers, the minimum pitch trim rates, the difference in trim up and down commands, and the difference in expected change in pitch and the actual change in pitch. If the relevant thresholds are satisfied by multiple relevant characteristics over multiple flights, then a fault will be diagnosed as a sensor or recorder fault. With respect to the values in Table 1, faults may be diagnosed with the sensor or the recorder if the comparison indicates that the relevant thresholds are surpassed by more than two of these features over more than three flights or if one of these features is grossly out of bounds.

By way of further example, a pitch range or rate calibration fault may be diagnosed based on comparing the median pitch trim position or the median pitch trim rate to a relevant threshold value. If the relevant thresholds are surpassed on more than a certain number of flights, then the fault will be diagnosed as a sensor calibration fault. As the threshold may be deemed to be satisfied when the threshold values in Table 1 are surpassed, this may also be phrased as being when the comparisons indicate that the thresholds are satisfied over multiple flights. As yet another example, it may be diagnosed that the automatic trim is inoperable if the difference between the number of trim up and down commands and the difference between the actual and the expected change in pitch satisfy corresponding reference pitch characteristic thresholds.

In implementation, the reference pitch characteristic and comparisons may be converted to an algorithm to diagnose faults in the horizontal stabilizer system 20. Such an algorithm may be converted to a computer program comprising a set of executable instructions, which may be executed by the controller 30 and/or the computer 40. Additional inputs to the computer program may include altitude, flap handle position, pitch trim position, whether the aircraft is in the air or on the ground, autopilot trim down command, autopilot trim up command, manual trim down command, manual trim up command.

At 108, the controller 30 and/or the computer 40 may provide an indication of the fault in the horizontal stabilizer system 20 diagnosed at 106. The indication may be provided in any suitable manner at any suitable location including on a primary flight display in the cockpit 16 and/or on a display at the ground station 42. For example, if the controller 30 ran the program, then the suitable indication may be provided on the aircraft 10 and/or may be uploaded to the ground system 42. Alternatively, if the computer 40 ran the program, then the indication may be uploaded or otherwise relayed to the aircraft 10. Alternatively, the indication may be relayed such that it may be provided at another location such as an airline control or flight operations department.

It will be understood that the method of diagnosing a horizontal stabilizer fault is flexible and the method illustrated is merely for illustrative purposes. For example, the sequence of steps depicted is for illustrative purposes only, and is not meant to limit the method 100 in any way as it is understood that the steps may proceed in a different logical order or additional or intervening steps may be included without detracting from embodiments of the innovation. By way of non-limiting example, the method 100 may also include receiving data relevant to a pitch of the aircraft during one flight or during a number of flights and that different faults may be detected using the results of the comparison over one flight versus over a number of flights. It will be understood that the number of flights used and the various thresholds set are all configurable. It will be understood that the controller 30 of the aircraft 10 and/or the computer 40 may receive the data, compare the received data, diagnose the fault, and provide the indication.

Effects of the above described embodiments include that data gathered by the aircraft during flight may be utilized to diagnose a horizontal stabilizer fault. This reduces maintenance times and the operational impact of faults and issues due to the horizontal stabilizer system. There may be a reduction in the time required to diagnose an issue and issues may be diagnosed accurately. This allows for cost savings by reducing maintenance cost, rescheduling cost, and minimizing operational impacts including minimizing the time aircraft are grounded.

This written description uses examples to disclose the innovation, including the best mode, and also to enable any person skilled in the art to practice the innovation, including making and using any devices or systems and performing any incorporated methods. The patentable scope of the innovation is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method of diagnosing a horizontal stabilizer system fault in an aircraft, the method comprising:
receiving data, from a sensor operably coupled to the horizontal stabilizer system, relevant to a characteristic of a pitch of the aircraft during flight;
comparing, by a controller, the received data to a reference pitch characteristic;
diagnosing, by a controller, a fault in the horizontal stabilizer system based on the comparison; and
providing an indication of the diagnosed fault.

2. The method of claim 1, wherein the received data is related to at least one of the following pitch characteristics: median pitch trim positions, median pitch trim rates, number of pitch trim position outliers, minimum pitch trim rates, a difference in trim up and down commands, or a difference in expected change in pitch and an actual change in pitch.

3. The method of claim 1, wherein the reference pitch characteristic is a threshold characteristic.

4. The method of claim 1, wherein the diagnosing the fault comprises the comparison indicating the received data is out of bounds.

5. The method of claim 1, wherein the received data is relevant to multiple pitch characteristics.

6. The method of claim 5, wherein the comparing comprises comparing the multiple pitch characteristics to corresponding multiple reference pitch characteristics.

7. The method of claim 1, wherein the received data comprises data for a number of flights.

8. The method of claim 1, wherein the diagnosing the fault comprises diagnosing the fault with a sensor or recorder when the comparisons indicate thresholds are satisfied by multiple relevant characteristics over multiple flights.

9. The method of claim 1, wherein the received data is related to autopilot minimum trim rates, a difference between the number of trim up and down commands, and a difference between an actual and expected change in pitch.

10. The method of claim 1, wherein the diagnosing the fault comprises diagnosing the fault with automatic trim when the comparisons indicate the relevant characteristics satisfy corresponding reference pitch characteristic thresholds.

11. The method of claim 1, wherein the received data comprises data for a number of flights.

12. The method of claim 1, wherein the received data comprises a median pitch trim position of the aircraft or a median pitch trim rate of the aircraft.

13. The method of claim 1, wherein the diagnosing the fault comprises diagnosing the fault with a sensor calibration when the comparing indicates thresholds are satisfied over multiple flights.

14. The method of claim 1, wherein a controller of the aircraft receives the data, compares the received data, diagnoses the fault, and provides the indication.

15. The method of claim 14, wherein the controller utilizes an algorithm to diagnose the fault.

16. The method of claim 2, wherein the reference pitch characteristic is a threshold characteristic.
